(19) United States
(12) Patent Application Publication
(10) Pub. No.: US 2011/0017663 A1
(43) Pub. Date: Jan. 27, 2011

(54) SYSTEM AND METHOD FOR SIMULTANEOUS BIOLOGICALLY MEDIATED REMOVAL OF CONTAMINANTS FROM CONTAMINATED WATER

(75) Inventors: Lutgarde Raskin, Ann Arbor, MI (US); Giridhar Upadhyaya, Ann Arbor, MI (US); Kim F. Hayes, Ann Arbor, MI (US); Jess C. Brown, Sarasota, FL (US)

Correspondence Address: JULIA CHURCH DIERKER;DIERKER & ASSOCIATES, P.C., 3331 W. BIG BEAVER RD. SUITE 109, TROY, MI, 48084-2813, US

(73) Assignees: The Regents of the University of Michigan, Ann Arbor, MI (US); Carollo Engineers, Inc., Phoenix, AZ (US)

(21) Appl. No.: 12/840,886

(22) Filed: Jul. 21, 2010

Related U.S. Application Data
(60) Provisional application No. 61/227,429, filed on Jul. 21, 2009.

(51) Int. Cl. C02F 3/00; C02F 3/34; C02F 3/02; C02F 3/30

(52) U.S. Cl. 210/617; 210/150

(57) ABSTRACT

A system and method for simultaneous biologically mediated removal of contaminants (including at least arsenic or nitrate) from water are disclosed herein. The system includes i) a bioreactor having a length suitable for housing at least three different microbial populations, or ii) two bioreactors coupled together, the two bioreactors each having a length and an empty bed contact time that together are suitable for housing at least three different microbial populations. The system also includes a biofilm attachment medium positioned in i) the bioreactor, or ii) the two bioreactors; and the at least three different microbial populations formed on the biofilm attachment medium. The microbial populations are selected from oxygen reducing microbes, nitrate reducing microbes, arsenate reducing microbes, sulfate reducing microbes, and uranium reducing microbes.

### CROSS-REFERENCE TO RELATED APPLICATIONS

This application is a utility of U.S. Provisional Patent Application Ser. No. 61/227,429, filed Jul. 21, 2009, entitled “System and Method for Simultaneous Biologically Mediated Removal of Contaminants from Contaminated Water,” which application is incorporated by reference herein in its entirety.

### BACKGROUND

The present disclosure relates generally to a system and method for the simultaneous biologically mediated removal of contaminants from contaminated water.

Water sources are often contaminated with various pollutants, some of which originate from anthropogenic and geogenic sources. Contamination may be of concern in the context of providing safe drinking water throughout the world. Regulatory pressures and anticipated regulations have resulted in the development of many different water treatment technologies. Examples of these contaminant removal processes include ion-exchange techniques and membrane filtration techniques.

### BRIEF DESCRIPTION OF THE DRAWING

Features and advantages of embodiments of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram of an embodiment of the system for simultaneously removing contaminants from contaminated water;

FIG. 2 is a schematic diagram of another embodiment of the system for simultaneously removing contaminants from contaminated water;

FIGS. 3A through 3C are graphs illustrating the nitrate (FIG. 3A), sulfate (FIG. 3B), and total arsenic (FIG. 3C) concentrations in the influent, the effluent of reactor 12 (EA), and the effluent of reactor 14 (EB) versus time of operation, the total empty bed contact time (EBCT) was changed on day 517 of reactor operation;

FIGS. 4A through 4C illustrate the chemical profiles of total arsenic and nitrate (FIG. 4A), sulfate and total iron (FIG. 4B), and acetate as carbon (FIG. 4C) along the depth of the reactor beds on day 538 of reactor operation, Inf represents the influent concentrations, A5-A8 and B1-B4 represent the respective sampling ports along the depth of reactors 12, 14, respectively, EA and EB represent concentrations in the effluents from reactor 12 and 14, respectively, the arrow indicates the location of additional Fe (II) (4 mg/L), the mean (n=3) values are reported with the error bars representing one standard deviation from the mean;

FIG. 5 is a graph depicting the X-ray diffraction pattern of solids collected from reactor 14 on day 503, the intensity is reported as counts per second (CPS) along the two-theta range of 10 to 70 degrees, characteristic pattern of mackinawite and greigite are shown for comparison (powder diffraction files 04-003-6935 and 00-016-0713, respectively);

FIGS. 6A and 6B are the X-ray absorption near edge structure spectrum (FIG. 6A) and its first derivative (FIG. 6B) of the solid sample collected on day 503 along with those of model compounds mackinawite and greigite;

FIGS. 7A through 7D illustrate the K-edge EXAFS fitting results for i) Fe (iron) in the k-space (FIG. 7A) and R-space (FIG. 7B) and ii) As (arsenic) in the k-space (FIG. 7C) and R-space (FIG. 7D) for the solids collected from reactor 14 on day 503 of reactor operation;

FIG. 8 is a schematic diagram of still another embodiment of the system for simultaneously removing nitrate and uranium from contaminated water, the solid arrows identify the water treatment line and the dotted arrows identify the backwash flow line;

FIG. 9 is a graph illustrating reactor influent and effluent concentrations of uranium and nitrate versus time of operation;

FIG. 10 is a graph illustrating the uranium, nitrate, and sulfate concentrations along the depth of the reactor, where “1”, “2”, and “3” represent sampling ports along the depth of the reactor; and

FIG. 11 is an X-ray absorption near edge structure spectrum of backwashed reactor solids compared with uraninite (UO₂(s)).

### DETAILED DESCRIPTION

Embodiments of the system and method disclosed herein advantageously enable the simultaneous removal of multiple contaminants from water (e.g., ground water, surface water, treated wastewater, etc.). One embodiment of the method involves the biological removal of at least nitrate and arsenic. It is to be understood that the system may be configured to remove other contaminants as well, including other redox active toxic elements that are subject to biological reduction including but not limited to perchlorate (Cl(VII)), bromate (Br(V)), chromate (Cr(VI)), selenate (Se(VI)), sulfate, and radioactive elements, such as uranium (U(VI)). Another embodiment of the method involves the biological removal of at least nitrate and uranium. The single system disclosed herein utilizes microorganisms naturally present in water to enable the removal of the contaminants by converting the contaminants to innocuous compounds or to compounds that can be converted to a stable form that is safe for disposal. More specifically, the system couples the oxidation of an electron donor substrate to the reduction of electron acceptors (e.g., dissolved oxygen, nitrate, iron(III), sulfate, arsenate, etc.). This coupling promotes the biologically mediated removal of nitrate, arsenic, and/or other contaminants using an engineered reactor system. The single system lends itself to a one-step treatment method with a small footprint. The system is relatively cost effective and relatively easy to operate compared to other technologies. Furthermore, the byproducts resulting from the process are limited and may be safely disposed of.

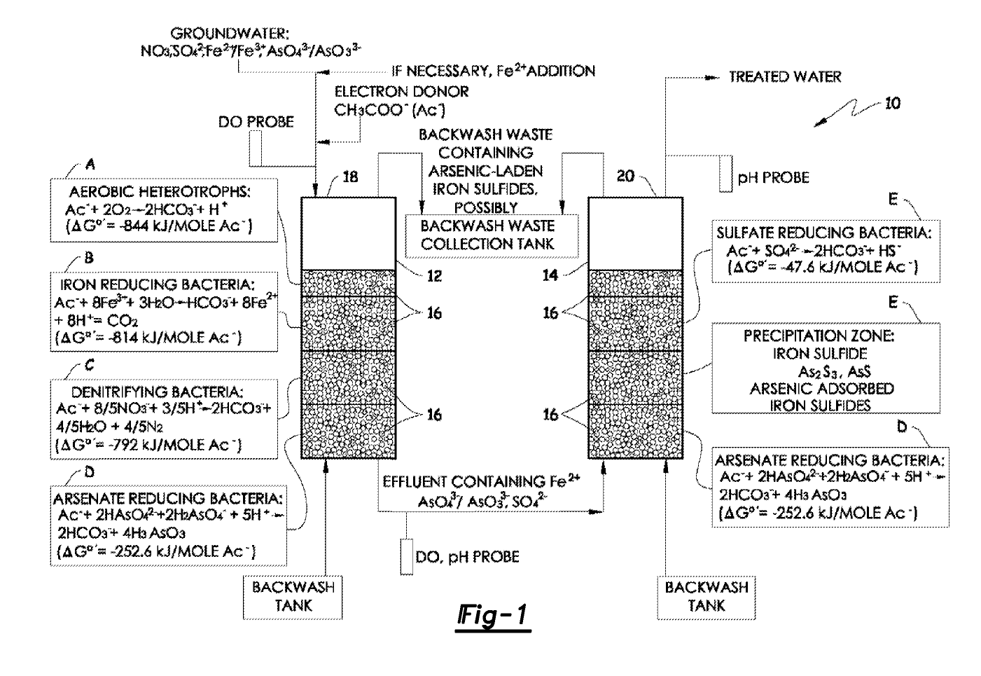

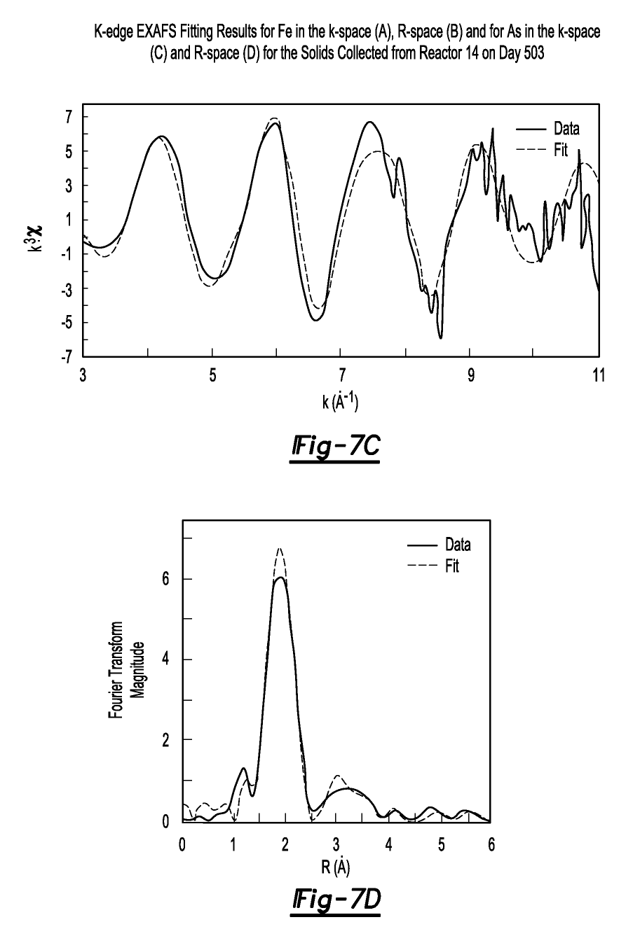

Referring now to FIG. 1, an embodiment of the system 10 is depicted. The system 10 may include a single bioreactor (see, e.g., FIG. 8), or two bioreactors 12, 14 that are hydraulically coupled to each other such that the effluent of the first bioreactor 12 is introduced into the second bioreactor 14. The two bioreactors 12, 14 are in series and, in one embodiment, form a continuous flow reactor system. It is to be understood that whether a single bioreactor or multiple bioreactors 12, 14 is/are used, the total depth of the medium in the bioreactor(s) in combination with the empty bed contact time (EBCT) are suitable for the development of redox conditions that allow the activity of at least three, and in some instances four or more different microbial populations (discussed further hereinbelow). When two reactors 12, 14 are used, the first reactor 12 may be shorter and have a shorter EBCT than the second reactor 14, or both reactors 12, 14 may be the same size and have the same EBCT. Non-limiting examples of EBCT times for the first reactor 12 may range from about 5 minutes to about 20 minutes. In one example, the EBCT for the first reactor 12 is about 10 minutes. Non-limiting examples of EBCT times for the second reactor 14 may range from about 10 minutes to about 30 minutes. When a particular time is referred to as “about” that time, it generally means the stated time ±1 minute. While the following description of FIG. 1 refers to the system 10 including two bioreactors 12, 14, it is to be understood that the single reactor system (see FIG. 8) may also be used to perform the method disclosed herein.

The bioreactors 12, 14 may be formed of glass, fiber glass, epoxy-coated steel columns, or other suitable materials.

The bioreactors 12, 14 are packed with a medium 16 to allow biofilm development in the system. Granular activated carbon (GAC) material has the advantage of providing sorptive capacity, which aids with the removal of some contaminants, but other attachment media (non-limiting examples of such materials include sand, plastic, pumice, etc.), may be used as well. When GAC is used as the attachment medium 16, after biofilm development occurs, this medium 16 is referred to as biologically active carbon (BAC). The amount of media 16 added to the bioreactors 12, 14 depends, at least in part, upon the desirable EBCT for the respective reactors 12, 14.

A contaminated water sample is introduced into the bioreactors 12, 14 simultaneously with an electron donor. Acetic acid or acetate as the electron donor has the advantage of being a compound that can be used by a very wide range of microorganisms, and can be safely added to drinking water treatment systems. It is to be understood that other electron donors may also be used, and non-limiting examples of such other electron donors include ethanol, glucose, glycerin, methanol, lactate, pyruvate, propionate, butyrate, etc. Contaminated water may contain nitrate (NO₃⁻), arsenate ions or arsenite ions (i.e., AsO₄³⁻ or AsO₃³⁻ or other dissolved species of As(III) and As(V)), and any other redox active elements (such as those noted herein). In addition, most waters contain sufficient quantities of sulfate (SO₄²⁻), ferrous iron (Fe(II) species) and/or ferric iron (Fe(III) species) to render the system 10 disclosed herein particularly effective for the removal of contaminants. In some instances, the water introduced does not contain sufficient quantities of iron or sulfate, and in such instances, it is desirable to amend the water with ferrous iron or sulfate, respectively.

Various microbial populations A, B, C, D, E establish themselves in the bioreactors 12, 14 after the material 16 is exposed to the contaminated water amended with the electron donor for a predetermined time. In one example, the microbial populations A, B, C, D, E begin to execute their desired activities within one week of contaminated water exposure, but establishment of optimal performance may take longer. It is to be understood that the microbial populations A, B, C, D, E may be established without providing an exogenous inoculum (i.e., rather, they are provided through the water to be treated), or may be inoculated into the reactor system 10 when suitable microbial biomass is available from other reactor systems to reduce startup time. In addition, trace elements, micronutrients, or vitamins may be provided to improve microbial performance when necessary (one non-limiting example includes the addition of low levels of phosphorus).

The microbial populations A, B, C, D, E are believed to be indigenous to the contaminated water to be treated. Microbes that develop in the reactors 12, 14 include oxygen reducing microbes A, ferric iron reducing microbes B (when ferric iron is present in the water), nitrate reducing microbes C, arsenate reducing microbes D, and sulfate reducing microbes E. The presence of additional contaminants will result in the establishment of additional microbial populations. While the microbial populations A, B, C, D, E are shown in FIG. 1 as occupying discrete areas of the bioreactors 12, 14, it is more likely that each population A, B, C, D, E is present as part of a mixed microbial community with various concentrations of the populations depending on the location in the reactors 12, 14. It is believed that the same microbes can perform several activities, depending, at least in part, on the availability of electron acceptors, and thus provide multiple roles in the system 10. The microbial populations A, B, C, D, E are shown as discrete areas within the bioreactors 12, 14 to illustrate how the populations A, B, C, D, E utilize the various electron acceptors present in the contaminated water sample sequentially, as water and a suitable electron donor (e.g., acetate) flow through the system 10 simultaneously.

It is believed that the system 10 operates via the sequential action of the microbes to reduce dissolved oxygen, ferric iron (when present), nitrate, arsenate, and sulfate in the contaminated water sample. The biologically-mediated reactions with the contaminated water constituents as electron acceptors and acetate as the electron donor are summarized in FIG. 1. Based on the standard free energies at pH 7 (ΔG^{o}′), the sequence of electron acceptor preference is:

O₂>Fe³⁺>NO₃⁻>H₂AsO₄⁻/HAsO₄²⁻>SO₄²⁻.

It is to be understood that since the electron acceptors are potentially present at widely varying concentrations (from ng/L to μg/L to mg/L levels) in contaminated water, this thermodynamically based sequence valid at standard conditions and pH 7 is not necessarily representative of all systems 10. As such, the biologically-mediated reactions involving the microbial populations A, B, C, D, E and the introduced contaminated water sample may occur in a different order than that shown in FIG. 1.

In the system 10 of FIG. 1, it is believed that oxygen reducing microbes A (e.g., aerobic heterotrophic bacteria) mediate the transfer of electrons from the electron donor to oxygen (present in the contaminated water) as the terminal electron acceptor. An example of this reaction is shown in accordance with microbial population A in FIG. 1.

If ferric iron (Fe(III)) is present in the contaminated water, the iron reducing microbes B (e.g., iron reducing bacteria from the genera Geobacter, Ferribacterium, Geothrix, etc.) oxidize the electron donor using the ferric iron in the contaminated water sample as the electron acceptor.

The next microbial population C consists of denitrifying bacteria that oxidize the electron donor using nitrate in the contaminated water as an electron acceptor. Non-limiting examples of denitrifying bacteria include bacteria from the genera Dechloromonas, Azospira, Acidovorax, Pelomonas, etc.). As a result, the nitrate present in the contaminated water sample is converted to nitrogen gas (N₂).

As previously mentioned, the extended length of the single bioreactor, or the use of the two bioreactors 12, 14 (the second 14 of which is downstream from the first 12) provides an environment that is suitable for achieving a desirable depth of material 16 and EBCT values that enable the growth of both arsenate (and/or organisms specific for other redox active contaminants, when present) and sulfate reducing microbes (present respectively as microbial populations D and E).

Using the electron donor provided, arsenate reducing microbes D reduce arsenate to arsenite, and sulfate reducing microbes E reduce sulfate to sulfide. Non-limiting examples of arsenate reducing microbes D include bacteria related to the Geobacter genus and other uncultured arsenate reducing bacteria. Non-limiting examples of sulfate reducing microbes E include bacteria related to the genera Desulfococcus, Desulfobacterium, Desulfonema, Desulfovibrio, Desulfotomaculum, Desulforegula, etc. At least some of the sulfides will react with ferrous iron (either present in the contaminated water sample, added to the system 10 with the contaminated water sample, or produced by iron reducing bacteria), resulting in precipitates of ferrous sulfides (e.g., amorphous iron sulfide, mackinawite, greigite, pyrrhotite or pyrite). The arsenite will adsorb onto the ferrous sulfides or will precipitate as arsenic sulfides, and then may be removed from the system 10. Similarly, other redox active contaminants would be reduced by organisms specific to those contaminants and be removed from the water by adsorbing to ferrous sulfide or by forming insoluble precipitates. FIG. 1 illustrates the biologically-mediated reactions that likely take place in the arsenic and sulfate reducing locations in the bioreactors 12, 14. The precipitates deposited in the bioreactor 14 can be removed by backwashing its bed.

The fixed-bed bioreactors 12, 14 disclosed herein utilize a stationary bed of the biofilm attachment medium 16 (e.g., the GAC material). A redox gradient develops across the bed, while (as discussed herein) the microbial populations A, B, C, D, E can use a variety of contaminants as their electron acceptors. As water is treated, the continuous growth of the microbial populations A, B, C, D, E may restrict flow, and may generate increasing head loss across the beds. As such, it is generally desirable to periodically backwash the system 10, at least to remove excess biomass from the bioreactor(s) 12, 14. It is believed that the desirable redox gradient will be reestablished after such a backwashing process. Precipitates may also be removed during the backwash cycle (which is discussed further hereinbelow).

In one embodiment, the backwash protocol involves introducing air and water simultaneously to the first reactor 12 in an upward-flow fashion once every 48 hours. Since there is much less biomass growth in the second reactor 14, this reactor 14 needs less frequent backwashing when compared to the bioreactor 12. For example, the second bioreactor 14 may be backwashed once every several months. It is to be understood that other backwash protocols may be suitable for the bioreactors 12, 14 disclosed herein, including, but not limited to different backwash intensities and frequencies, and the use of nitrogen gas (e.g., to maintain reduced conditions) rather than air.

Backwashing the system 10 advantageously impacts the hydraulics through the bed and decreases the concentration of active biomass. As a result, short-circuiting of the system 10 is avoided. It is to be understood, however, that removal of excessive amounts of active biomass may result in poor performance of the system 10 after backwashing. Additionally, removal of iron sulfides may reduce the arsenic (or other adsorbing contaminants) removal capacity of the system 10 and increase the amount of waste to be disposed of. As such, nitrate and arsenic effluent concentrations may be monitored immediately after a backwash event, and biomass and inorganic solids concentrations may be determined in the backwash water. Evaluating both effluent and backwash water characteristics immediately after backwashing enables one to evaluate whether the intensity of backwashing was sufficient or excessive, and to adjust subsequent backwashing processes accordingly.

Backwashing the system 10 also advantageously removes the precipitated material (i.e., the reduced forms of arsenic and sulfate). The removed precipitates may then be readily disposed of.

The backwash waste should be settled or filtered before disposing of the liquid. The generated sludge may be taken to a non-hazardous or hazardous landfill depending, at least in part, upon whether the total arsenic concentration in the leachate (as determined by the toxicity characteristic leaching procedure (TCLP)) is less or more than 5 mg/L.

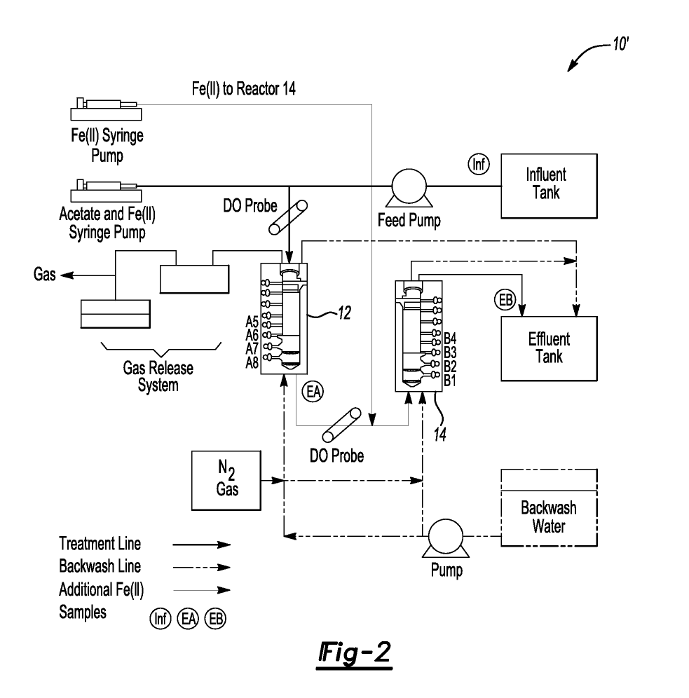

FIG. 2 illustrates another embodiment of the two-reactor system 10′ including multiple microbes (not labeled) formed in the reactors 12, 14, and multiple sampling ports A5-A8 and B1-B4. This embodiment illustrates other components that may be used in the system 10′ (or 10), including syringe pumps for introducing iron and acetate into the reactors 12 and/or 14, an influent tank and feed pump for introducing the influent into reactor 12, a gas release system, a nitrogen gas or compressed air tank for introduction of nitrogen gas or compressed air into the reactors 12 and/or 14, probes for testing the level of dissolved oxygen, a backwash water tank used for both reactors 12, 14, and an effluent tank for collecting the effluent from reactor 14. The key in the lower left-hand corner of FIG. 2 shows that the solid-lined arrows represent the water treatment line, the dashed-line arrows represent the backwash line, and the dotted-line arrows represent the additional Fe(III) samples.

It is to be understood that arsenic removal by iron sulfide precipitation also provides an extra level of protection when the ultimate fate is disposal of immobilized arsenic in landfills (one of the few disposal methods currently available). Under reducing conditions that develop in landfills, arsenic solid precipitates formed with ferrous sulfide in the BAC reactor are not subject to reductive dissolution that could otherwise result in the release of Fe(II), and of As(III) and As(V) present in the solid wastes. The sulfide associated with the iron or arsenic solids will protect against this release mechanism, at least in part because the sulfide solids are stable under reducing conditions. Furthermore, should oxidizing conditions occur for short periods of time in a landfill, the ferric oxyhydroxide solids produced from the oxidation of ferrous sulfides will protect against oxidative mobilization by adsorbing any released contaminant associated with sulfide solid phases. When samples of arsenic reacted with iron sulfides at circumneutral pH are exposed to oxygen, the iron oxyhydroxide solid phases formed effectively capture any arsenic temporarily released to solution during the oxidation process.

Embodiments of the system 10 may also be suitable for removing arsenic alone. Some water is contaminated with arsenic and not nitrate, and the system 10 disclosed herein may be used to treat such contaminated water.

Embodiments of the system 10 disclosed herein may be a continuous system, in which contaminated water and electron donor are continuously introduced into the bioreactors 12, 14, and from which purified water is continuously removed from the bioreactors 12, 14. Other embodiments of the system 10 may be non-continuous systems which are operated when it is desirable to test a particular water sample or, for example, during operating hours of a plant or lab in which the system 10 resides.

It is believed that the EBCT should be optimized for each water sample to be treated in order to achieve complete contaminant removal at minimal cost. In order to determine the optimal EBCT, the EBCT may be lowered in a step-wise manner while electron donor addition is maintained constant. As mentioned hereinabove, EBCTs for reactors 12 and 14 may be 15 and 20 min, respectively, or less if performance is deemed to be acceptable. It is also desirable to minimize the electron donor addition to limit the residual electron donor concentration in the final effluent and operate the system at the lowest possible cost. The electron donor addition can be estimated through stoichiometric calculations once the composition of the water to be treated is known. A safety factor can initially be applied, but optimization experiments may indicate that the safety factor can be reduced.

To further illustrate embodiment(s) of the present disclosure, examples are given herein. It is to be understood that these examples are provided for illustrative purposes and are not to be construed as limiting the scope of the disclosed embodiment(s).

### Example 1

### Reactor and Operational Details

A schematic diagram of the bioreactor system used in this Example is shown in FIG. 2.

Two glass columns (labeled 12 and 14) were used. Each column 12, 14 had a 4.9 cm inner diameter and a 26 cm height. BAC particles were collected from a bench-scale and a pilot-scale bioreactor previously operated for nitrate and perchlorate removal. The BAC particles were packed into the reactors 12 and 14 to obtain a bed volume of 200 cm³ in each reactor 12, 14. Granular activated carbon (GAC), having an effective size of 1.4 mm, was used to generate the BAC particles in the bioreactor previously operated for nitrate and perchlorate removal. The microbial communities, which developed in the bench-scale and a pilot-scale nitrate and perchlorate removing bioreactor, originated from various sources, including groundwater and a GAC filter operated at a full-scale drinking water treatment plant in Ann Arbor, Mich. Each reactor 12, 14 included eight sample ports, four of which are labeled on each reactor (e.g., A5-A8 of reactor 12 and B1-B4 of reactor 14).

The composition of the arsenic contaminated synthetic groundwater used as the influent solution is shown in Table 1.

TABLE 1
Chemical composition of the synthetic groundwater amended with acetate

| Chemical | Concentration | Unit |
|---|---|---|
| NaNO₃ | 50.0 | mg/L as NO₃⁻ |
| NaCl | 13.1 | mg/L as Cl⁻ |
| CaCl₂ | 13.1 | mg/L as Cl⁻ |
| MgCl₂•6H₂O | 13.1 | mg/L as Cl⁻ |
| K₂CO₃ | 6.0 | mg/l as CO₃²⁻ |
| NaHCO₃ | 213.5 | mg/L as HCO₃⁻ |
| Na₂SO₄ | 22.4 | mg/L as SO₄²⁻ |
| Na₂HAsO₄•7H₂O | 0.2 | mg/L as As |
| H₃PO₄ | 0.5 | mg/L as P |
| FeCl₂•4H₂O^{a,b} | 6.0 | mg/L as Fe²⁺ |
| CH₃COOHa | 35.0 | mg/L as C |

^{a}added as concentrated solution through a syringe pump; the concentrations in the table represent the concentrations after mixing of the concentrated solution and the influent
^{b}in addition to the supplementation of FeCl₂•4H₂O to reactor 12, a concentrated solution of 5 FeCl₂•4H₂O was added to reactor 14 using a syringe pump to provide an additional 4 mg/L as Fe(II) to the system

The influent (80L) was purged with oxygen free N₂ gas for 40 minutes to remove dissolved oxygen (DO) from the synthetic groundwater to below 1 mg/L. Maintaining the DO level below 1 mg/L was accomplished by covering the influent tank with a floating cover and purging the synthetic groundwater with oxygen free N₂ gas for 20 minutes every 24 hours. 23 mg/L acetate as carbon was estimated to be needed to completely remove the electron acceptors (i.e., residual DO, nitrate, arsenate, and sulfate). This estimation was based upon an average net yield of 0.4 g biomass/g COD. Utilizing a safety factor of 1.5, the influent acetic acid concentration was maintained at 35 mg/L acetic acid as carbon.

During the first 50 days of reactor operation, the reactor operating temperatures were 18° C. After the first 50 days, the reactors were operated at room temperature (21.5±0.7° C.), with the influent fed to reactor 12 in a down-flow mode using a peristaltic pump. A concentrated solution of glacial acetic acid and FeCl₂.4H₂O salt was fed (using a syringe pump) to the influent line and to reactor 12. As such, the dissolved acetic acid and Fe(II) concentrations fed to the system were equivalent to those reported in Table 1. The concentrated solution of acetic acid was autoclaved and equilibrated in an anaerobic glove box, and then the FeCl₂.4H₂O salt was added. This solution was then filtered twice through respective 0.22 μm filters and pumped into the reactor 12.

In order to promote complete removal of any sulfide formed by sulfate reduction, a concentrated solution of dissolved FeCl₂.4H₂O salt was directly fed to reactor 14 through a syringe pump to add an additional 4 mg of Fe(II) per L of feed. The FeCl₂.4H₂O solution was prepared in an anaerobic chamber using de-ionized (DI) water and was acidified to a final concentration of 0.02 N HCl.

The effluent of reactor 12 was introduced into reactor 14 in an up-flow fashion.

Reactor 12 was backwashed every 48 hours to remove any dislodged biomass. Backwashing was accomplished using a mixed flow of DI water (50 mL/min) and N₂ gas to completely fluidize the filter bed for 2 minutes, and then a flow of DI water 2 (500 mL/min) for 2 minutes. The reactor 14 was also backwashed following the same procedure for backwashing reactor 12. However, backwashing of reactor 14 was performed approximately every 3-4 months. During the data collection period that is reported herein, reactor 14 was backwashed only on day 503 of reactor operation.

Changes in the operating conditions were occasionally implemented to maintain or enhance performance of the system. Examples of operating conditions that may be varied include, but are not limited to flow rates and/or EBCT. In this example, the influent flow rate was maintained at 10 mL/min to achieve an EBCT of 20 minutes in each reactor 12, 14, thus a total EBCT of 40 minutes.

To optimize the EBCT, the bed volume of reactor 12 was adjusted to 150 cm³ (changing the EBCT to 15 minutes), 100 cm³ (changing the EBCT 10 minutes), and 70 cm³ (changing the EBCT to 7 minutes), while maintaining the flow rate of 10 mL/min and the bed volume of the second reactor 14. Each EBCT condition was evaluated for a minimum of 30 days. On day 517 of reactor operation, 66% of the BAC in reactor 12 was replaced with BAC from the same stock used initially to pack the reactors 12, 14. The replacement BAC had been stored at 4° C. for approximately 17 months. Also on day 517 of reactor operation, the EBCT of reactor 12 was increased to 10 minutes and the EBCT of reactor 14 was maintained at 20 minutes, providing a total EBCT of 30 minutes.

### Collection and Chemical Analyses of Water Samples

Every 24 hours, samples were taken from the influent tank (Inf), the first effluent (EA), and the final effluent (EB). On day 538 of reactor operation, liquid profile samples were collected from the sampling ports of each reactor. The samples were filtered, stored at 4° C., and analyzed within 48 hours.

If the samples were to be tested for total arsenic and total iron, these samples were acidified to a final concentration of 0.02 N HCl before storage. Some of these samples were analyzed using an ion coupled plasma mass spectrometer (ICP-MS) (PerkinElmer ALEN DRC-e, Waltham, Mass.) with detection limits of 2 μg/L As_{T} and 0.1 mg/L Fe_{T}, respectively. Others of these samples, particularly those for arsenic speciation, were analyzed within 24 hours using a Dionex AS4A-SC column (Dionex, Sunnyvale, Calif.) combined with ICP-MS. The eluent contained 1.5 mM oxalic acid and was provided at a flow rate of 2.5 mL/min. Both As(V) and As(III) were detectable at a level 18 of 2.5 μg/L As.

CellO×325 sensors in WTW D201 flow cells (Weilheim, Germany) were connected to the inlet and outlet of reactor 12. Dissolved oxygen (DO) levels in the influent and the effluent from reactor 12 were measured using WTW multi340 meters with these sensors. The detection limit for DO was 0.01 mg/L.

An ion chromatography system (Dionex, Sunnyvale, Calif.) fitted with a Dionex DX 100 conductivity detector was used to measure acetate, nitrate, nitrite, chloride, and sulfate. The detection limit for each of the anions was 0.2 mg/L. Chromatographic separation was achieved using a Dionex AS-14 column (Dionex, Sunnyvale, Calif.). The anions were eluted through the column with a mixture of ACS reagent grade 1 mM bicarbonate and 3.5 mM carbonate at a flow rate of 1 mL/min.

### Collection and Chemical Analyses of Gas Samples

A gas tight syringe was used to take gas samples from the upper part of the reactor 12. The protocol described by Pantsar-Kallio and Korpela (“Analysis of gaseous arsenic species and stability studies of arsine and trimethylarsine by gas chromatography-mass spectroscopy”, Analytica Chimica Acta 410 (1-2), 65-70 (2000)) was modified to analyze gas samples collected from the upper part of reactor 12 for the presence of toxic gases of arsenic. These toxic gases included arsine, monomethylarsine, dimethylarsine, and trimethylarsine. The gas tight syringe was used to inject 250 μL gaseous samples (using helium as a carrier gas) into an HP 5890 series II GC 10 interfaced to a HP 5972 Mass Spectrometer. The system was fitted with a DB-5 capillary column (0.25 mm 12 I.D.×60 m) with 1 micron film thickness. The analyses were performed isothermally at 36° C. with the mass spectrometer operated in single ion monitor. The detection limits for arsine, monomethylarsine, dimethylarsine, and trimethylarsine were as follows, respectively: 1 ng/μL, 3 ng/μL, 2 ng/μL, and 2 ng/μL as As.

It was also desirable to assess the presence of nitrous oxide gas (N₂O), which is an intermediate of denitrification. This was accomplished using an HP 5890 4 series II gas chromatograph equipped with a Poraplot-Q column (0.53 mm I.D.×25 m) and an electron capture detector.

### X-ray Analyses

It was also desired to analyze the solids deposited on the reactor bed in reactor 14. As such, reactor 14 was backwashed on day 503 of operation to collect these solids. The backwash was accomplished as previously described, and was transferred to an anaerobic chamber filled with a mixture of 3% H₂ and 97% N₂. The solids were vacuum-filtered within the anaerobic chamber.

One portion of the vacuum-filtered solids was maintained as a wet paste and was transferred to 20 mL serum bottles. The bottles were sealed, and were shipped to the Stanford Synchrotron Radiation Lightsource (SSRL) for arsenic and iron X-ray absorption spectroscopy (XAS) data collection. The XAS samples prepared for iron analyses were diluted using boron nitride to obtain a concentration high enough for a suitable signal but low enough to prevent self-absorption (20:1, boron nitride: sample by mass). Sample preparation and loading were performed in an anaerobic chamber. Arsenic K-edge (11867 eV) and iron K-edge (7112 eV) X-11 ray absorption spectra were collected at the beam line 11-2 using a 30-element Ge detector or Lytle detector at the beam energy of 3.0 GeV and maximum beam current of 200 mA. Fluorescence spectra of the wet paste samples were collected using a low temperature cryostat filled with liquid nitrogen. The monochromator was detuned 35% for As and 5% for Fe at the highest energy position of the scans in order to minimize the contribution from the higher order harmonics. The beam energy was calibrated using the simultaneously measured As or Fe standard foil spectrum. Eleven and eight scans were collected for the As and Fe samples, respectively, in an effort to obtain improved signal to noise ratios.

The remaining portion of the vacuum filtered solids was freeze-dried and ground (using a mortar and pestle) in the anaerobic chamber. X-ray diffraction (XRD) patterns of the freeze-dried powdered samples were obtained using a Rigaku Rotaflex rotating anode X-ray diffractometer (Cu 6 Kα radiation, 40 kV, 100 mA).

### Data Analyses

FEFF8, IFEFFIT, SIXPAK, and EXAFSPAK codes (Ankudinov et al., FEFF8, The FEFF Project, Department of Physics, University of WA (2002); George and Pickering, EXAFSPAK, A Suite of Computer Programs for Analysis of A-ray Absorption Spectra, Stanford Synchrotron Radiation Laboratory, Stand Linear Accelerator Center, Menlo Park Calif. (2000); Newville, The IFEFFIT Tutorial, Consortium for Advanced Radiation Sources, University of Chicago, Chicago, Ill. (2001)) were used to perform data analysis. In general, the following occurred: acceptable signal channels were selected; numerous scans were averaged after 1 energy calibration; and backgrounds were removed using linear fits below the absorption edge and spline fits above the edge using the IFEFFIT code. The spectra were then converted from the energy to the frequency space using the photo electron wave vector k in the range of 3<k<11 for As and 3<k<12 for Fe. EXAFS fitting was performed using SIXPAK with phase shift and amplitude functions for backscattering paths obtained from FEFF8 calculations with crystallographic input files generated using ATOMS program. The Debye-Waller factor (σ²) and energy reference E₀ parameters were also floated during the fitting to obtain optimal structural parameters, including coordination number (CN) and inter-atomic distances (R). To reduce the number of fitting parameters, the many-body factor S₀² was fixed at 0.9. Furthermore, in order to ensure results were consistent and not dependent on the fitting algorithms used, EXAFS fitting was performed using EXAFSPAK and was compared to those obtained by SIXPAK.

### Results—Reactor Performance

The results reported herein are from 503 to day 543 of reactor operation. During this time period, the following results were recorded:
the pH of the effluents of reactors 12 and 14 was 7.2±0.5 (mean±standard deviation);
dissolved oxygen (DO) levels in the influent (Inf) and the first effluent (EA) averaged 0.77±0.50 mg/L and 0.02±0.01 mg/L, respectively; and
dissolved nitrite and gaseous nitrous oxide (intermediates of denitrification) were respectively never detected in the effluents of either of the reactors 12, 14 or in the gas collected from the upper part of the first reactor 12.

Furthermore, it is noted that arsenic removal was not observed during system startup, as the arsenic concentration in the final effluent remained equivalent to the influent level for the first 50 days of operation. After increasing the operating temperature from 18° C. to 22° C. on day 50, sulfate reduction started on day 54 and arsenic removal was observed soon thereafter (data not shown).

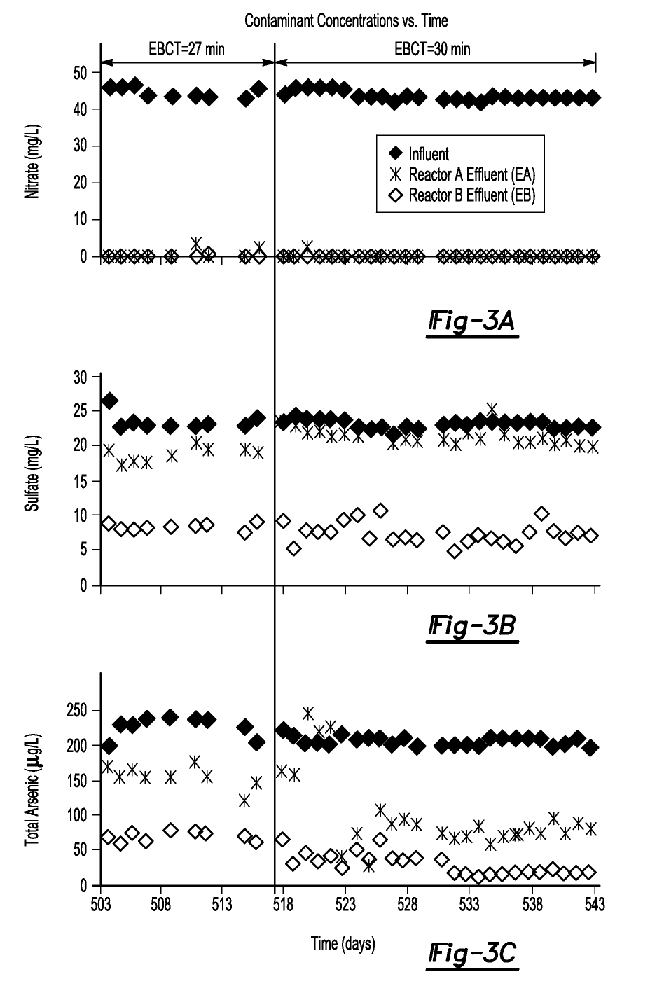

From operating days 503 to 517, reactor 12 was operated at an EBCT of 7 minutes and reactor 14 was operated at an EBCT of 20 minutes. As such, the total EBCT was 27 minutes. At this relatively low EBCT of reactor 12, nitrate was occasionally carried over into reactor 14 (see FIG. 3A). In order to avoid this, the EBCT in reactor 12 was increased to 10 minutes on day 517. At this time, the EBCT in reactor 14 was maintained at 20 minutes, and thus the total EBCT was increased to 30 minutes. The increase in reactor 12 and total EBCT resulted in complete nitrate removal in reactor 12 (see again FIG. 3A).

Prior to operating day 517, reactors 12 and 14 removed 3.4±1.9 mg/L and 15.8±1.5 mg/L sulfate, respectively. After increasing the EBCT of reactor 12, sulfate removal in reactors 12 and 14 was similar to the previous period (1.5±1.1 and 15.4±1.7 mg/L, respectively).

Aqueous phase arsenic speciation analyses (As(III) and As(V) dissolved species) were not performed during operating days 503 to 543. However, previous speciation analyses indicated that arsenate was reduced to arsenite and removed through precipitation with biogenically produced sulfides or surface precipitation and adsorption on iron sulfides. From days 503 to 517, the arsenic concentration in the final effluent averaged 41±22 m/L 14 (see FIG. 3C). However, as illustrated in FIG. 3C, the arsenic level in the final effluent decreased to below 20 μg/L on day 532. Furthermore, none of the gaseous arsenic species (i.e., arsine, monomethylarsine, dimethylarsine, and trimethylarsine) were detected in the gas collected from the upper part of the first reactor 12.

### Results—Concentration Profiles Along the Depth of the Bioreactors

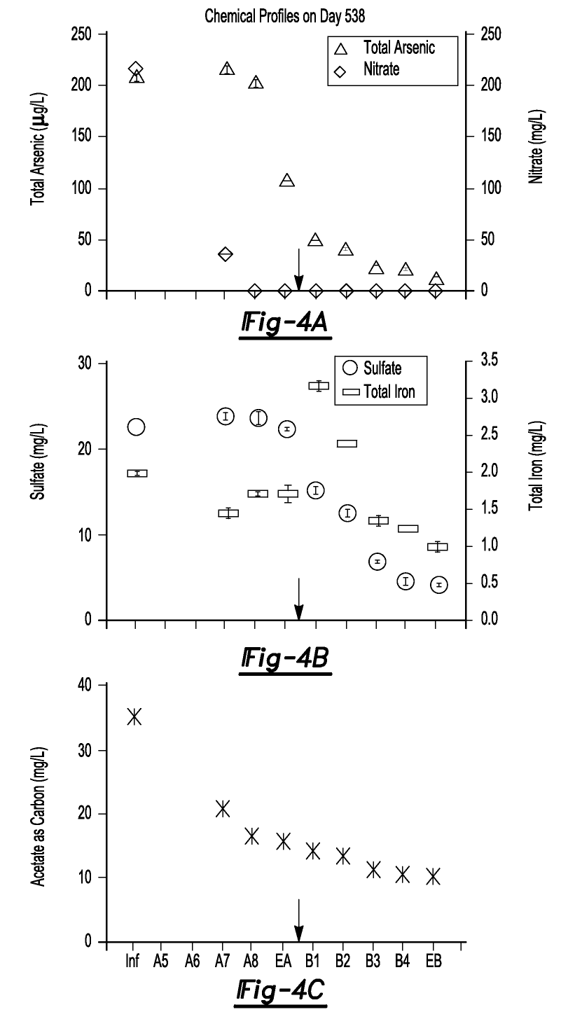

Samples taken on day 538 indicated a sequential utilization of DO (data not shown), nitrate (see FIG. 4A), and sulfate (see FIG. 4B). In particular, nitrate was completely removed in reactor 12. This was indicated by a nitrate concentration below the detection limit in port A8. Sulfate reduction began after nitrate removal was complete (i.e., after port A8 in reactor 12).

Acetate consumption corresponded with the utilization of the electron acceptors. As shown in FIG. 4C, between the influent (Inf) and port A8 of reactor 12 where DO and nitrate were utilized as the electron acceptors, 18.5±0.1 mg/L of acetate as carbon was consumed. Similarly, the remainder of acetate consumption between port A8 and the final effluent (6.3±0.1 mg/L of acetate as carbon) corresponded to the amount of acetate required for the measured amount of sulfate reduced.

Iron and arsenic depletion from the aqueous phase followed the trend of sulfate reduction (see FIGS. 4A and 4B). 101±2 μg/L of arsenic was removed in reactor 12, while the arsenic level was further reduced in reactor 14 to a final effluent (EB) concentration of 13±0.3 μg/L.

The arrows in FIGS. 4A through 4C indicate the location where additional Fe(II) was added in the system. The precipitation of iron sulfides removed 0.3±0.1 mg/L iron in reactor 12 and 4.7±0.1 14 mg/L of iron in reactor 14.

As the results illustrate, DO, nitrate, arsenate, and sulfate present in the synthetic groundwater were sequentially reduced when coupled with acetate oxidation. Iron was present in the influent in the form of Fe(II). Despite the presence of low levels (<1 mg/L) of DO in the influent, no visual presence of Fe(III) hydroxides (e.g., brownish orange particles) were observed at the inlet of the bioreactor 12. This suggested the rapid utilization of the small residual of DO from the influent tank. Although DO was not measured along the depth of the reactors 12, 14, DO utilization is expected (based on thermodynamic favorability) to be the first terminal electron accepting process (TEAP) to occur at the inlet of the reactor 12.

As seen in FIGS. 4A through 4C, effective nitrate removal was accomplished. Nitrate levels were below detection at sampling port A8 and beyond (e.g., in reactor 14). Gibb's free energies of reaction were calculated at standard conditions and pH of 7 for nitrate, arsenate, and sulfate reduction using acetate as the electron donor. These calculated free energies are: −792 kJ/mole for nitrate, −252.6 kJ/mole for arsenate, and −47.6 kJ/mole for sulfate. These calculations indicate that arsenate reduction is expected after nitrate reduction under equivalent electron acceptor concentration conditions. While the data is not shown herein, arsenic speciation measurements made during the first part of reactor operation showed a predominance of arsenite (As(III)) in the effluent from reactor 12, thereby confirming that arsenate reduction took place.

The absence of detectable nitrite and nitrous oxide suggested complete denitrification in reactor 12. As previously discussed, prior to day 517, the EBCT in reactor 12 was 7 minutes and nitrate was occasionally present in the second reactor 14. During those periods when nitrate was present in reactor 14, the TEAP zones for arsenate and sulfate reduction were likely shifted toward the end of reactor 14. Even though total sulfate reduction was not impacted, poor arsenic removal was observed during this time period. This may have been due, at least in part, to the shifting TEAP zones. It is believed that arsenate reduction, sulfate reduction, and the presence of iron(II) should occur proximally in order to obtain effective arsenic removal through precipitation/co-precipitation. The poor reactor performance observed during the periods of nitrate leaking to the reactor 14 suggests that maintaining stable TEAP zones may be important for optimal arsenic removal.

The chemical analyses of the liquid samples along the depth of the reactors indicated that sulfate reduction corresponded with arsenic removal. Since arsenite (As(III)) can react with sulfide (S(—II)) and result in the formation of arsenic sulfides (such as orpiment (As₂S₃) and the more reduced form, realgar (AsS)), it is possible that arsenic was removed through the precipitation of these solids. However, in the presence of iron(II), it is equally likely that the formation of iron sulfide minerals were responsible for lowering the arsenic concentrations. Examples of the iron sulfide minerals may include the mackinawite, greigite, and pyrite. In a system containing iron(II), sulfides, and arsenic, it is expected that arsenic removal will take place primarily by adsorption/co-precipitation with iron sulfides rather than by precipitation of arsenic sulfides alone. This expectation is due, at least in part, to the difference in the solubility of iron and arsenic. In the embodiment of the system used in this example, iron depletion from the liquid phase followed the pattern of sulfate reduction along the flow direction (see FIG. 4B). This indicates that iron sulfides were generated, and removed arsenic from the liquid phase. It is further believed that the iron sulfides may aid in inhibiting the formation of methyl arsine species (e.g., arsine, monomethylarsine, dimethylarsine, and trimethylarsine, which were not detected).

The removal of arsenic from the aqueous phase along the depth of the reactors 12, 14 was accomplished using the biological reduction of arsenate to arsenite and the interaction of biogenic sulfides with arsenite. It is believed that the systems disclosed herein may be optimized to achieve arsenic concentrations in the final effluent below 10 μg/L by further adjusting the amount of iron and sulfate additions.

### Results—Solids Characterization

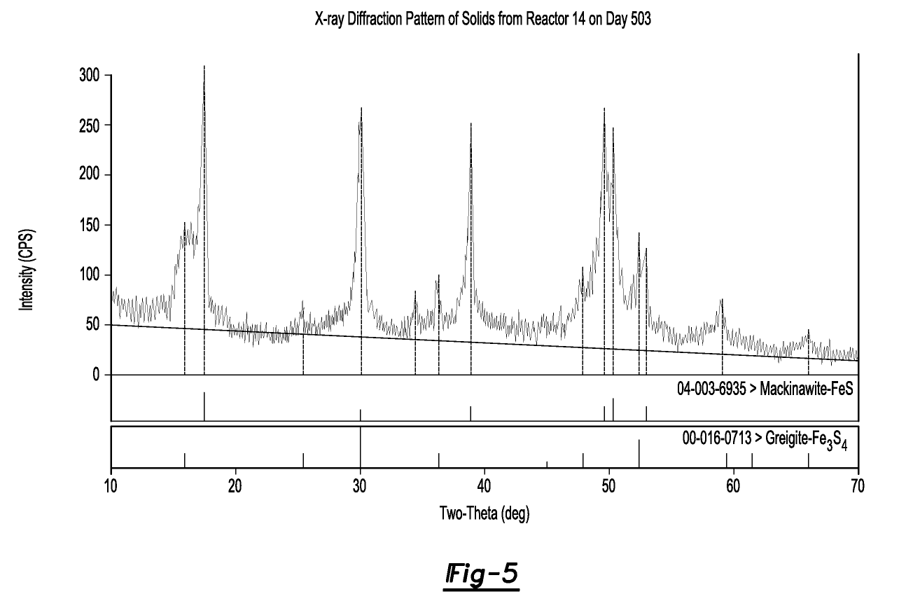

XRD analysis indicated the presence of mackinawite (tetragonal FeS) and greigite (Fe₃S₄) as the solids deposited in the reactor system (see FIG. 5).

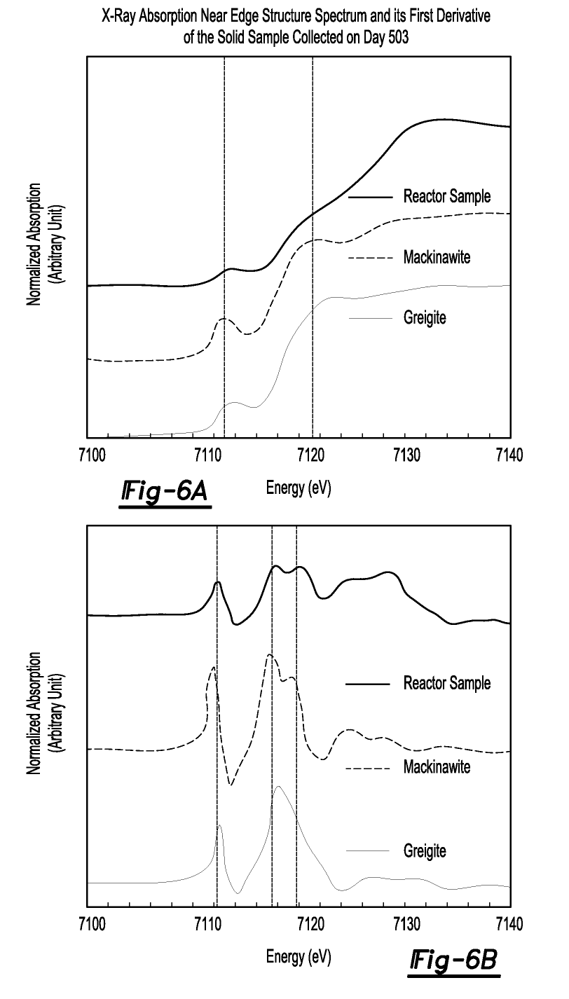

X-ray absorption near edge structure (XANES) and extended X-ray absorption fine structure (EXAFS) analyses were also performed on the XAS data collected. An Fe XANES plot of the solids collected from the second reactor 14 and chemically synthesized pure model compounds mackinawite and greigite is presented in FIG. 6A. The corresponding first derivative plot of the solids collected from the second reactor 14 and chemically synthesized pure model compounds mackinawite and greigite is presented in FIG. 6B. By comparing the peak positions and shapes for the sample and the pure model compounds, one can conclude that the major iron phase in the sample is mackinawite. In particular, the results for the sample shown in FIG. 6B illustrate the first derivative with a singlet at 7112 eV and a doublet between 7118 and 7120 eV, which are characteristic of mackinawite. As such, this comparison suggests that the solid sample collected from reactor 14 is mainly composed of mackinawite rather than greigite.

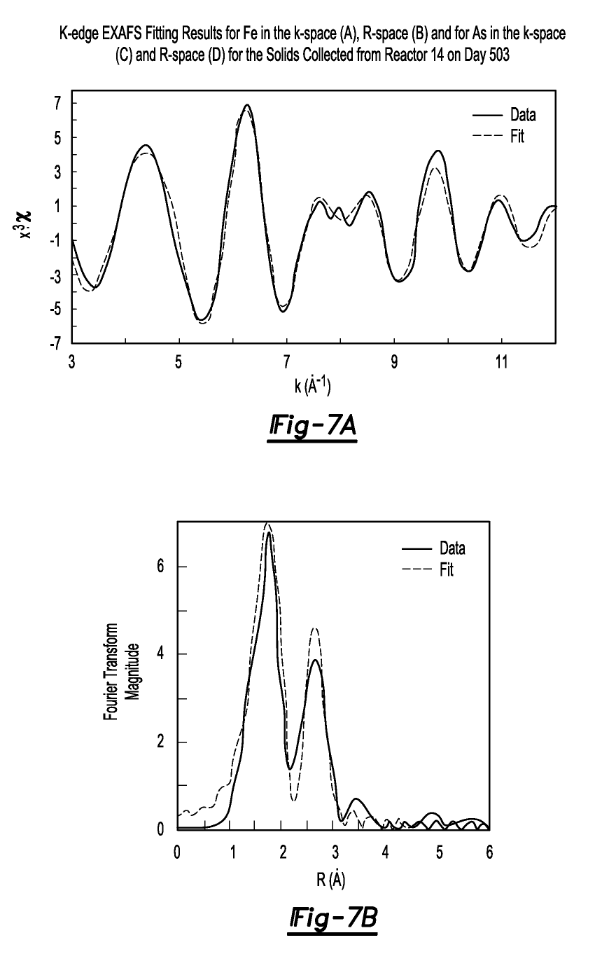

EXAFS fitting results and the structural parameters extracted from the fitting are given in FIGS. 7A through 7D and in Table 2.

TABLE 2
Structural parameters

| | | | | | Fit value |
|---|---|---|---|---|---|
| Data | Path | CN | R | σ² | (R factor) |
| Fe K edge | Fe—S | 5.5 | 2.23 | 0.0133 | 0.2568 |
| | Fe—Fe | 1.8 | 3.04 | 0.0045 | 0.0192 |
| As K edge | As—S | 2.2 | 2.29 | 0.0048 | 0.0845 |
| | As—As | 4.4 | 3.56 | 0.0184 | 0.0551 |

The iron K-edge EXAFS analysis (FIGS. 7A and 7B) indicates that Fe atoms are coordinated by 5.5 S atoms at 2.23 Å with σ² of 0.0133 and 1.8 Fe atoms at 3.04 Å with σ² of 0.0045. These structural parameters are indicative of mackinawite. The EXAFS analysis of arsenic K-edge X-ray absorption spectrum indicates that As has 2.2 S atoms at 2.29 Å with σ² of 0.0048 (see Table 2 and FIGS. 7C and 7D). These structural parameters are in agreement with the arsenic-sulfur bond found in solid phases, and with the reported As—S bond distance of 2.25 Å from the EXAFS analysis of solid phase products of arsenic when reacted with mackinawite at circumneutral pH. Taken together, these results implicate the formation of arsenic sulfide as the primary arsenic removal mechanism in the bioreactor. The arsenic sulfide may either be formed as a bulk precipitate (i.e., three dimensional structures) or as a surface precipitate (i.e., two dimensional arrays) on iron sulfide particles. These results, however, do not rule out the possibility of arsenic adsorption on iron sulfides as an additional removal mechanism.

As previously mentioned, arsenic was likely removed from the liquid phase through surface precipitation on iron sulfide surfaces and direct arsenic sulfide precipitation. Adsorption on iron sulfides may have provided additional arsenic removal. Even though orpiment precipitation requires acidic conditions, arsenic sulfide precipitation could occur in local environments or as a result of microbial activity. The EXAFS analyses support this interpretation at least in part because the results confirmed Fe—S and As—S coordination, which is consistent with the formation of iron sulfide and arsenic sulfide solid phases.

### Example 2

FIG. 8 illustrates a schematic diagram of the bioreactor system 100 used and the reactions that were mediated by each microbial population in this example. This embodiment of the system 100 includes a single reactor 12′ having the oxygen reducing, nitrate reducing, and uranium reducing microbes formed therein. The mixed microbial community was seeded to reactor 12′ from the arsenic and nitrate removing bioreactor (described above in Example 1). This microbial community was used to remove uranium and nitrate from a synthetic groundwater (see Table 3).

TABLE 3
Influent Synthetic Groundwater amended with Acetate

| | | Concentration |
|---|---|---|
| Chemical | | (mg/L) |
| NaNO₃ | As NO₃⁻ | 50.2 |
| NaCl | as Cl⁻ | 13.1 |
| CaCl₂ | as Cl⁻ | 13.1 |
| MgCl₂•6H₂O | as Cl⁻ | 13.1 |
| K₂CO₃ | as CO₃²⁻ | 6.0 |
| NaHCO₃ | as HCO₃⁻ | 213.5 |
| Na₂SO₄ | As SO₄²⁻ | 22.0 |
| NaH₂PO₄ | as P | 0.5 |
| UO₂(NO₃)₂ | as U | 0.3 |
| CH₃COOH | as C | 20.0 |

Granular activated carbon (GAC) was used as the support media in the bioreactor 12′. The single reactor 12′ was made of a glass column, and included sampling ports along the depth of the reactor 12′.

The initial EBCT was 20 minutes, which was later (on day 58) shortened to 14 minutes.

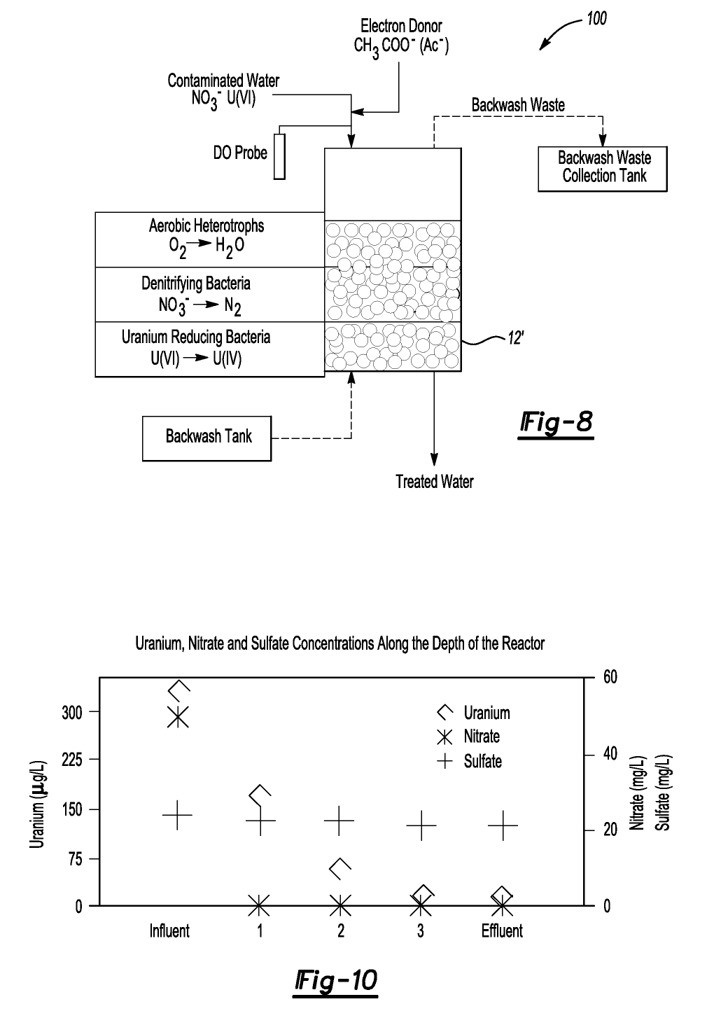

Acetate concentrations started at 35 mg C/L. These concentrations were lowered to 16 mg C/L on day 43 (see FIG. 9), and then increased to 20 mg C/L on day 46. By purging the influent with N₂ gas and using a floating cover, the dissolved oxygen in the influent was maintained below 1 mg/L.

In order to remove excess biomass, backwashing was performed in the reactor 12′ about every 7 days. In this example, backwashing was accomplished by flowing N₂ purged water and N₂ gas opposite to the sample flow direction.

Liquid samples from the influent, effluent, and sampling ports along the depth of reactor 12′ were collected. These samples were analyzed for pH, nitrate, acetate, sulfate, and uranium. The samples were filtered and stored at 4° C. until analysis. The samples to be analyzed for total uranium were acidified to a final concentration of 0.06 N HCl. Total uranium was measured with an ion coupled plasma mass spectrometer (ICP-MS) (PerkinElmer ALEN DRC-e, Waltham, Mass.).

Nitrate, acetate, and sulfate were analyzed with ion chromatography with a Dionex DX 100 conductivity detector and AS-14 column (Dionex, Sunnyvale, Calif.). The detection limit for each of these anions was 0.2 mg/L. The anions were eluted through the column with 1 mM bicarbonate and 3.5 mM carbonate with a flow rate of 1 mL/min.

The long-term reactor influent and effluent concentrations of uranium and nitrate are shown in FIG. 9. It is noted that the acetate pump failed on day 11 and that an oxygen leak was detected on day 21.

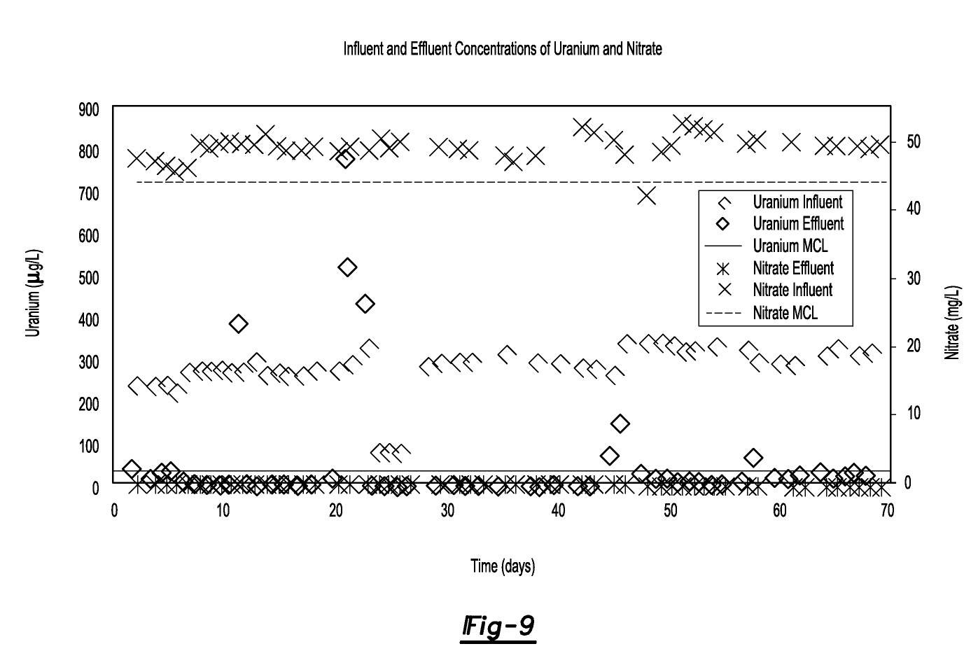

The uranium, nitrate and sulfate concentrations along the depth of the reactor are shown in FIG. 10. As illustrated, the bioreactor 12′ effectively removed both uranium and nitrate from the effluent.

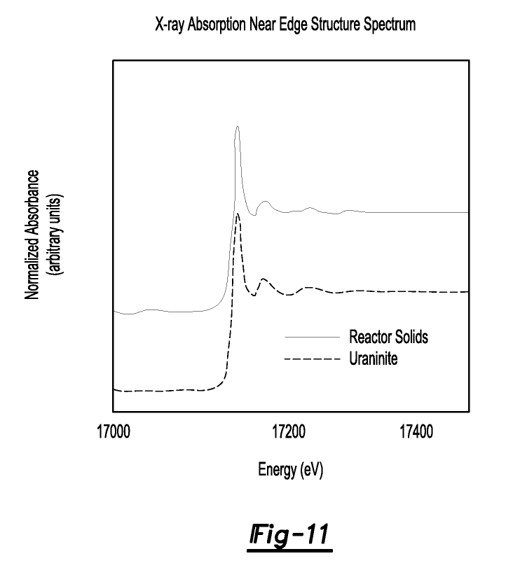

Residual uranyl ions were removed from the backwash solids (taken from the reactor 12′) by washing the solids with 100 mM bicarbonate buffer. The solids were then analyzed with X-ray absorption spectroscopy (XAS) at Stanford Synchrotron Lightsource (SSRL). U L3-edge (17166 eV) data were collected at beamline 4-1 using a Lytle detector. The beam energy was calibrated using the simultaneously measured Y (yttrium) standard foil spectrum. The X-ray absorption near edge spectrum of the backwashed reactor solids compared with uraninite is shown in FIG. 11. These results illustrate that uranium was removed from the sample.

In some of the embodiments disclosed herein, the microbial populations A, B, C, D, E in the fixed-bed bioreactors 12, 14 are capable of reducing at least dissolved oxygen, ferric iron, nitrate, arsenate, and sulfate in a sequential manner (along the direction of flow). In other embodiments disclosed herein, the microbial populations in the single fixed-bed bioreactor 12′ are capable of reducing at least dissolved oxygen, nitrate, and uranium in a sequential manner (along the direction of flow). The reactions take place in a single system 10 upon introducing water to reactor 12 (and then to reactor 14 from reactor 12) or 12′, and thus the contaminants may be removed from the water simultaneously. It is believed that the presence of arsenic or uranium does not inhibit the activity of microbes essential to the operation of the entire system 10, 10′, or 100, and that the presence of ferrous iron (produced chemically under reducing conditions, biologically by iron reducing bacteria, or added if necessary) and biologically produced sulfide result in precipitation of iron sulfides, and concomitant removal of arsenic due to adsorption onto iron sulfides or co-precipitation of arsenic sulfides. As mentioned herein, the bioreactors 12, 14 or 12′ are also capable of removing other contaminants, such as perchlorate, bromate, chromate, selenate, and other redox active radioactive materials that dissolve in water.

While several embodiments have been described in detail, it will be apparent to those skilled in the art that the disclosed embodiments may be modified. Therefore, the foregoing description is to be considered exemplary rather than limiting.

What is claimed is:

1. A system for simultaneous, biologically mediated removal of contaminants including at least arsenic or nitrate from water, the system comprising:
i) a bioreactor having a length and empty bed contact time suitable for housing at least three different microbial populations, or ii) two bioreactors coupled together, the two bioreactors each having a length and an empty bed contact time that together are suitable for housing at least three different microbial populations;
a biofilm attachment medium positioned in i) the bioreactor, or ii) the two bioreactors; and
the at least three different microbial populations formed on the biofilm attachment medium, the microbial populations being selected from oxygen reducing microbes, nitrate reducing microbes, arsenate reducing microbes, sulfate reducing microbes and uranium reducing microbes.

2. The system as defined in claim 1, further comprising ferric iron reducing microbes when ferric iron is present in the water.

3. The system as defined in claim 1 wherein the system includes the two bioreactors, wherein a first bioreactor houses at least the oxygen reducing microbes, and the nitrate reducing microbes, and wherein a second bioreactor houses the arsenate reducing microbes, and the sulfate reducing microbes.

4. The system as defined in claim 3 wherein the second bioreactor further includes a precipitation zone where i) reduced arsenic produced by the arsenate reducing microbes and sulfide produced by the sulfate reducing microbes precipitate as arsenic sulfides or ii) arsenic is removed by adsorbing to produced iron sulfides.

5. The system as defined in claim 2 wherein the first reactor length and empty bed contact time that is shorter than or equal to the length and the empty bed contact time of the second reactor.

6. The system as defined in claim 1 wherein the at least three different microbial populations form a redox gradient within i) the bioreactor, or ii) the two bioreactors.

7. The system as defined in claim 1, further comprising a backwash system operatively connected to i) the bioreactor or ii) the two bioreactors, the backwash system configured to remove biomass and precipitates from the system.

8. The system as defined in claim 1, further comprising microbes that are capable of reducing water soluble redox active species selected from the group consisting of perchlorate, bromate, chromate, and selenate.

9. The system as defined in claim 1 wherein a depth of the biofilm attachment medium, in combination with the empty bed contact time, allow redox conditions to develop in the i) bioreactor, or ii) two bioreactors.

10. The system as defined in claim 1, further comprising:
the water introduced into the bioreactor or the two bioreactors; and
an electron donor present in the water or introduced into the water.

11. The system as defined in claim 1 wherein the system includes the one bioreactor, wherein the bioreactor houses at least the oxygen reducing microbes, the nitrate reducing microbes, and the uranium reducing microbes.

12. A method for simultaneously removing contaminants including at least arsenic or nitrate from contaminated water, the method comprising:
providing a system including:
i) a bioreactor having a length and an empty bed contact time suitable for housing at least three different microbial populations, or ii) two bioreactors coupled together, the two bioreactors each having a length and an empty bed contact time that together are suitable for housing at least three different microbial populations;
a biofilm attachment medium positioned in i) the bioreactor, or ii) the two bioreactors; and
the at least three different microbial populations formed in the biofilm attachment medium, the plurality of microbial populations being selected from oxygen reducing microbes, nitrate reducing microbes, arsenate reducing microbes, sulfate reducing microbes, and uranium reducing microbes; and
simultaneously introducing i) contaminated water including ferric iron, sulfate, and an electron donor, or ii) contaminated water, ferrous iron, sulfate, and an electron donor into an inlet of the i) bioreactor, or ii) a first of the two bioreactors, thereby initiating a series of reactions to remove at least the arsenic and the nitrate from the contaminated water sample.

13. The method as defined in claim 12 wherein the system further includes microbes that are capable of reducing water soluble redox active species selected from the group consisting of perchlorate, bromate, chromate, and selenate.

14. The method as defined in claim 12, further comprising backwashing the bioreactor or the two bioreactors to remove excess biomass and precipitates therefrom.

15. The method as defined in claim 12 wherein the series of reactions include reduction of oxygen, reduction of nitrate, reduction of arsenate, and reduction of sulfate.

16. The method as defined in claim 12 wherein the series of reactions include reduction of oxygen, reduction of nitrate, and reduction of uranium.

17. The method as defined in claim 12 wherein the system further includes ferric iron reducing microbes, and wherein the method further comprises reducing ferric iron present in the contaminated water to generate ferrous iron.
